(19) United States
(12) Patent Application Publication
(10) Pub. No.: US 2001/0016697 A1
(43) Pub. Date: Aug. 23, 2001

(54) METHODS AND APPARATUS FOR STIMULATING GINGIVA

(76) Inventor: MICHAEL GORSEN, MANHATTAN BEACH, CA (US)

Correspondence Address: ERIC K SATERMO, PO BOX 19099, IRVINE, CA, 926239099

(21) Appl. No.: 09/288,338

(22) Filed: Apr. 8, 1999

Related U.S. Application Data
(60) Provisional application No. 60/081,153, filed on Apr. 9, 1998.

(51) Int. Cl. A61H 1/00

(52) U.S. Cl. 601/80

(57) ABSTRACT

A tissue stimulator includes a body with a motor, a head attached to the body, and an applicator attached to a distal portion of the head. The head has a vibrating mechanism which, in conjunction with the motor, vibrates the distal portion at a sonic frequency. The applicator has a contact surface with a surface area. The surface area is relatively large so as to impart to tissue a substantial portion of the vibration of the distal portion. The tissue stimulator is particularly useful for massaging gingiva.

### FIELD OF THE INVENTION

The present invention relates to devices which massage or stimulate tissue. More particularly, the present invention relates to devices which promote blood flow in the gingiva through vibrant stimulation, thereby aiding in oral hygiene.

### BACKGROUND OF THE INVENTION

It has been shown that dental hygiene may be improved massaging the gums, or gingiva. Such massage stimulates the flow of blood through the gingiva, which results in stronger and healthier tissue.

One device that has been developed for massaging the gingiva is a cone-shaped attachment disposed on the end of a toothbrush. The attachment is made from resilient rubber. A user may then position the tip of the attachment at the gum line and between teeth to massage the gums manually by moving the arm and/or hand.

One of the drawbacks of such a device is that it is relatively flexible so that the user cannot impart a vigorous massage to the gums. In addition, the surface area of the attachment that actually contacts the gums is small; accordingly, the user is only able to massage a correspondingly small area of the gums at one time. Substantial time and effort is required to massage the entire mouth.

In view of the foregoing, it is apparent that there is still a need in the art for a device that is able to massage gingiva in a vigorous, fast, and stimulating manner.

### SUMMARY OF THE INVENTION

According to one aspect of the invention, tissue stimulator includes a body with a motor, a head attached to the body, and an applicator attached to a distal portion of the head. The head has a vibrating mechanism which, in conjunction with the motor, vibrates the distal portion at a sonic frequency. The applicator has a contact surface with a surface area. The surface area is relatively large so as to impart to tissue a substantial portion of the vibration of the distal portion.

The tissue stimulator is particularly useful for massaging gingiva. By massaging gingiva at sonic frequencies with an applicator having a relatively large contact surface area, for example, on the order of about 1 cm², unexpected beneficial results are provided. Conventional sonic toothbrush heads are only able to impart a very small portion of the sonic vibration on the tissue, because of the high flexibility of the bristles. In addition, the cross-sectional area of each bristle is extremely small, with the collective contact surface area of the bristles being extended over a relatively large area of gingiva. Accordingly, only a small percentage of the sonic energy generated by the motors of conventional sonic toothbrushes is transferred from the head to the gingiva. Analogous arguments apply to conical shaped rubber attachments.

Additional aspects, features, and advantages of the present invention will become apparent to those persons having ordinary skill in the art to which the present invention pertains from the following description taken in conjunction with the accompanying drawings.

### BRIEF DESCRIPTION OF THE SEVERAL VIEWS OF THE DRAWINGS

FIG. 1 is a perspective view of an exemplary embodiment of a tissue stimulator of the present invention, particularly illustrating a stimulator configured for massaging gingiva;

FIG. 2 is a cross-sectional view of an exemplary applicator of the invention, taken along line 2-2 of FIG. 1;

FIG. 3 is a cross-sectional view of the applicator, taken along line 3-3 of FIG. 1;

FIG. 4 is a schematic view of the tissue stimulator massaging gingiva, shown in partial cross section;

FIG. 5 is a schematic view of the tissue stimulator massaging gingivae, shown in plan;

FIG. 6 is a cross-sectional view of an exemplary applicator of the present invention, particularly illustrating a releasably attachable applicator;

FIG. 7 is a cross-sectional view of another exemplary releasably attachable applicator;

FIG. 8 is a cross-sectional view of an exemplary applicator and distal portion of a head of the stimulator;

FIG. 9 is a schematic view of another exemplary embodiment of a vibrant applicator of the present invention;

FIG. 10 is a schematic view of yet another exemplary embodiment of a vibrant applicator of the present invention;

FIG. 11 is a schematic view of still another exemplary embodiment of a vibrant applicator of the present invention;

FIG. 12 is a schematic view of a further exemplary embodiment of a vibrant applicator of the present invention;

FIG. 13 is a schematic view of another exemplary embodiment of a vibrant applicator of the present invention;

FIG. 14 is a schematic view of another exemplary embodiment of a vibrant applicator of the present invention;

FIG. 15 is a schematic view of another exemplary embodiment of a vibrant applicator of the present invention, shown in side view;

FIG. 16 is a schematic view of the applicator shown in FIG. 15, shown in plan view;

FIG. 17 is a cross-sectional view of yet another exemplary embodiment of a vibrant applicator of the present invention; and

FIG. 18 is a schematic view of the applicator of the invention, particularly illustrating resilient properties thereof.

### DETAILED DESCRIPTION OF THE INVENTION

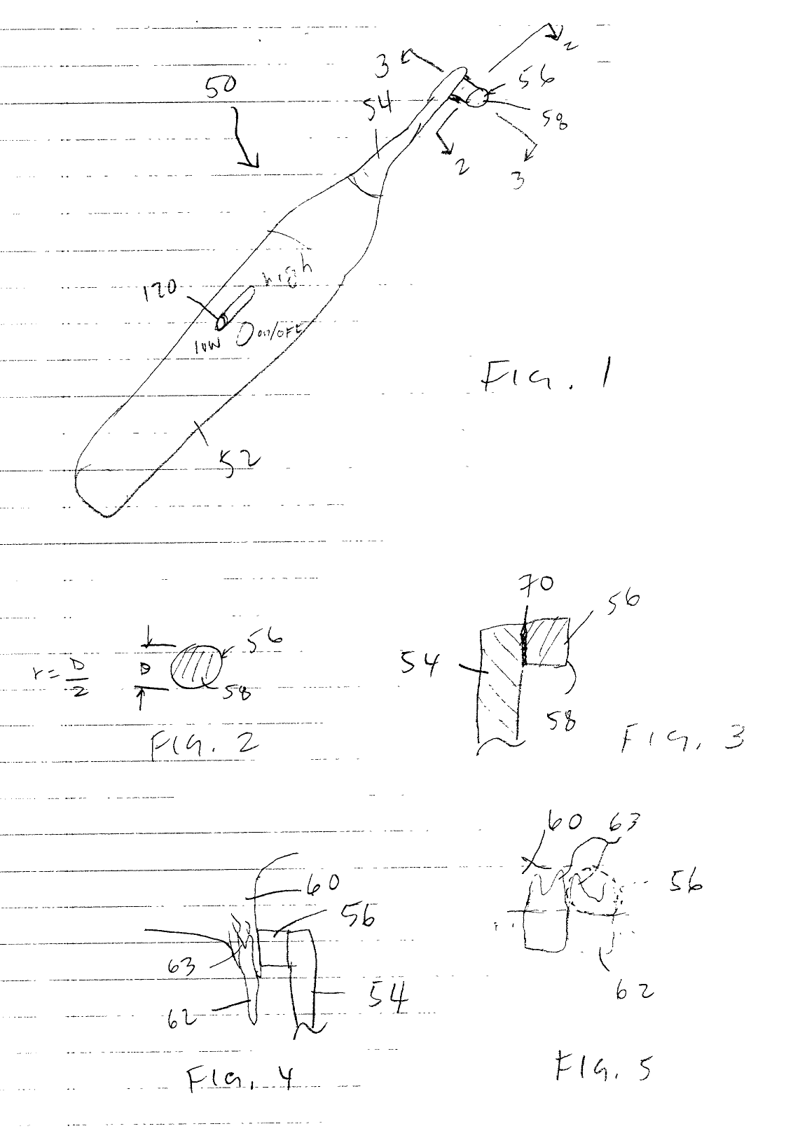

Referring more particularly to the drawings, an exemplary tissue stimulator 50 configured in accordance with the teachings of the present invention is illustrated in FIG. 1. For purposes of explanation and without limiting the scope of the present invention, exemplary stimulator 50 is illustrated as a device for stimulating gingivae or the gums of the mouth through vibrant massage. Exemplary gingiva stimulator 50 is preferably hand-held, cordless, portable, and rechargeable. The principles of the present invention may be readily modified for other tissue-stimulating applications, including devices for stimulating other types of tissue, for example, muscle and skin, and other parts of the body, for example, the back, the scalp, the feet, and the hands.

Exemplary stimulator 50 includes a main body 52 and a head 54 which is preferably releasably engagable with the main body. An applicator 56 is attached to and projects outwardly from the head 54. With additional reference to FIGS. 2 and 3, exemplary applicator 56 may be cylindrical and made from a solid piece of material, such as a biocompatible plastic. Exemplary applicator 56 has a contact surface 58 for contacting tissue to be stimulated, such as gingiva. As shown in FIG. 3, exemplary contact surface 58 is substantially planar, although other configurations are possible, as discussed below. Contact surface 58 has a diameter D and a corresponding radius r, which yields a surface area of approximately πr².

Exemplary body 52 includes a motor portion, and exemplary head 54 includes vibrating or oscillating mechanisms which are compatible with the motor portion, which are not shown in the drawings. The motor portion and the vibrating mechanisms are configured to operate so that the head 54 vibrates at frequencies extending into the sonic range, for example, on the order of about 500 Hz. Body and head may be configured in accordance with U.S. Pat. Nos. 5,189,751 and 5,378,153 to Giuliani et al., both of which patents are incorporated herein by reference. Each of these patents discloses body and head devices which impart an oscillating frequency in the range of about 40 Hz to 500 Hz. Optiva Corporation of Bellevue, Wash., the assignee of said patents, produces a sonic toothbrush under the trade name sonicare®. This sonic toothbrush operates a 31,000 cycles per minute, or about 516 Hz. Teledyne Water Pik™ of Fort Collins, Colo., produces a sonic toothbrush under the trade name SenSonic™. Each of these devices includes a toothbrush head at the distal portion of the head. Exemplary body 52 and head 54 may be configured in accordance with the sonic technology of these conventional devices.

In a preferred embodiment of the invention, exemplary contact surface 58 has a diameter D of about 1.1 centimeters (cm), which yields a surface area of about 0.95 cm². The inventor of the present invention has determined that by massaging the gingiva at sonic frequencies with a stimulator 56 that has a contact surface area of on the order of about 1 cm², unexpected beneficial results are provided. Conventional brush heads are only able to impart a very small portion of the sonic vibration on the tissue because of the high flexibility of the bristles. In addition, the cross-sectional area of each bristle is extremely small, with the collective contact surface area of the bristles being extended over a wide range of gingiva. Accordingly, only a small percentage of the sonic energy generated by the motors of conventional sonic toothbrushes is transferred from the toothbrush head to the gingiva. In other words, a large percentage of the vibrating energy in the form of kinetic energy provided by the head 54 is not utilized. Generally speaking, for gingival applications, the contact surface area may be at least about 0.2 cm², and may preferably range from about 0.5 cm² to about 1.5 cm². Depending upon the application, the contact surface area may be as large as desired, especially for tissue of large mass such as muscle tissue.

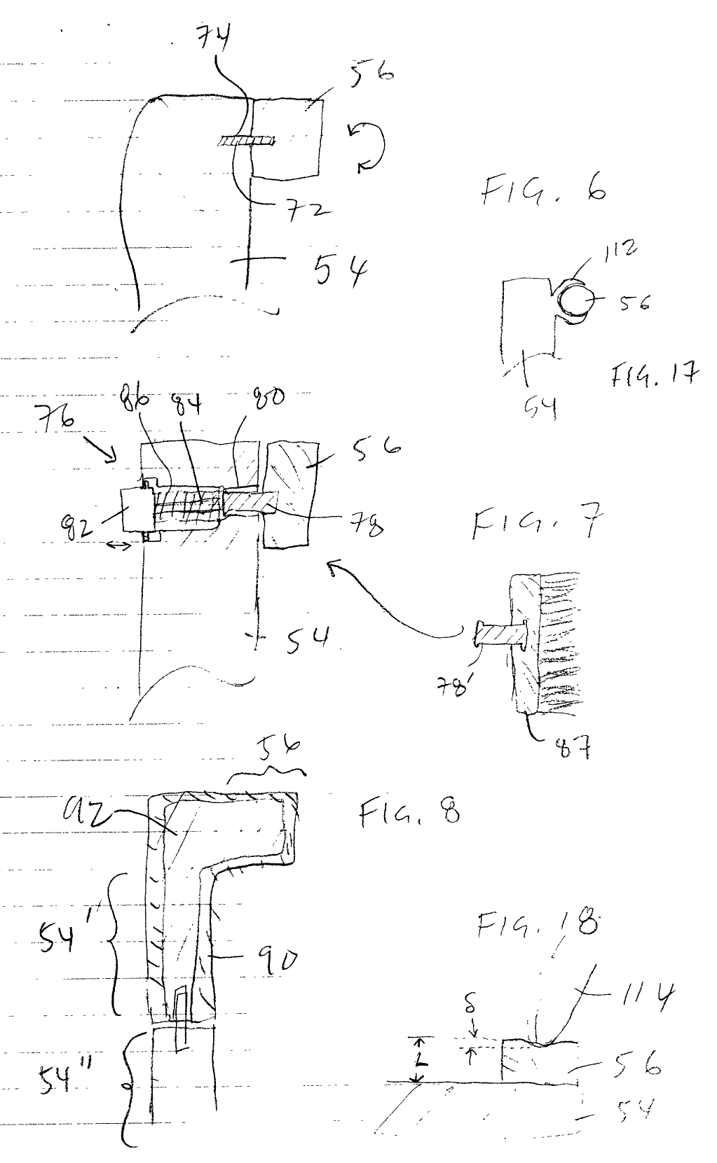

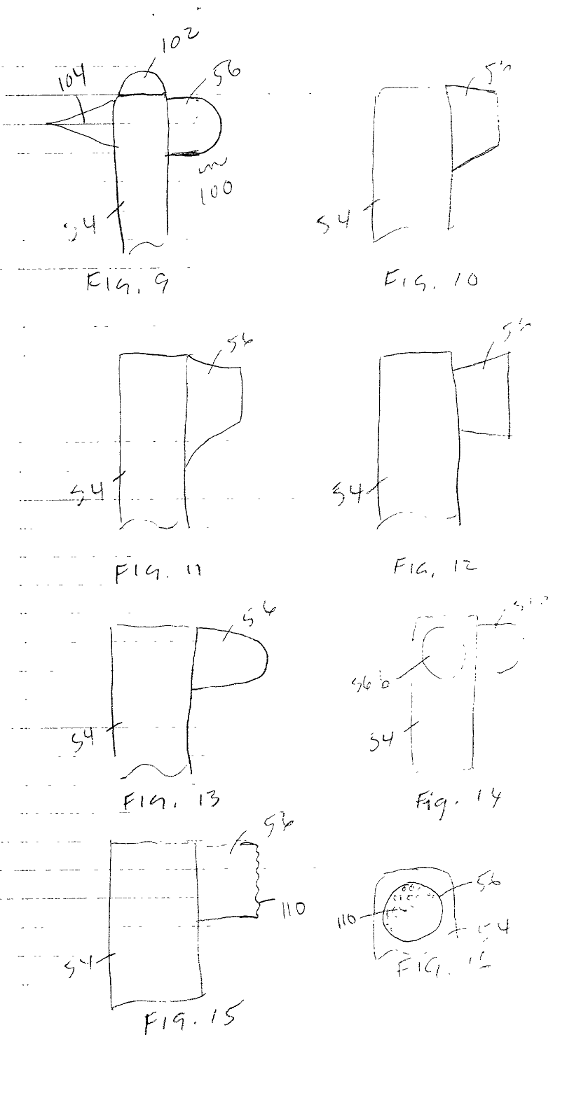

However, in accordance with the present invention, exemplary applicator 56 has a relatively large contact surface area and is made from material which, although having a certain resiliency, is substantially firm. As shown in FIGS. 4 and 5, the large-surface-area applicator 56 contacts a relatively large portion of the gingiva, which is referenced by numeral 60, to stimulate circulation of blood within the gingiva, especially at the roots of teeth 62. The stimulation of blood within the gingiva 60 enhances the health of the gingiva, reverses the effects of gingivitis, and prevents the occurrence of gingivitis. In addition, because of the large contact surface area, the gum line is able to be effectively massaged and stimulated, which is not possible with currently available products. This relatively large gum-line stimulation ability of the present invention is advantageous in that the bond between the gums and the enamel of the teeth is strengthened and tightened, thereby reducing and substantially eliminating pockets which may form between the teeth and the gums in which food debris may lodge.

In addition, as shown in phantom line in FIG. 5, the relatively large-sized applicator 56 is able to impart or apply vibrating kinetic energy to the area of the gums 60 surrounding roots 63 of the teeth 62, thereby stimulating blood flow throughout the entire root system of a tooth or of two adjacent teeth simultaneously. This feature of the invention has many advantages, including speed, in that the entire gingiva may be massaged in a relatively short amount of time. This encourages users to employ the gingiva stimulator 50 on a regular basis in their dental hygiene regime. Also, the sonic vibration effectively applied by the stimulator substantially prevents plaque from adhering to the enamel of the teeth.

As shown in FIG. 5, the diameter D (see FIG. 2) of the contact surface 58 may be on the order of or approximately equal to the width of a tooth to stimulate the entire root system of a tooth simultaneously. As the width of teeth varies from person to person and as the width of the types of teeth varies (from incisor to cuspid to molar), the diameter D of the contact surface may range from about 0.3 cm to about 1.5 cm for gingival applications.

As shown in FIG. 3, exemplary applicator 56 may be attached to the distal portion of the head 54 by, for example, adhesive 70. This type of attachment is preferably permanent. Alternatively, applicator 56 may be releasably attached to the head 54, as shown in FIG. 6. For example, applicator 56 may include a threaded member 72 for engaging with a complementary threaded socket 74 formed in the head 54 (or, vice versa, the threaded member 72 may be a component the head with the socket 74 being formed in the applicator). Accordingly, differently configured applicators in accordance with the invention may be attached to the head 54 for various applications or for patients with different needs. For example, each member of a family may have their own applicator 56 for use with only one body-and-head combination 52 and 54. Each member of the family may then thread on their own applicator 56 for use. In this embodiment, the head 54 may be permanently attached to the body 52. Exemplary configurations of the applicator 56 will be discussed in more detail below.

Discussing the interchangeable applicators 56 of the present invention further, reference is made to FIG. 7. In this embodiment, exemplary stimulator 50 includes a quick-release mechanism 76 disposed on the head 54. Exemplary quick-release mechanism 76 enables a user to interchange different applicators 56 in a fast and easy manner. To do so, applicator 56 may include a post 78 for engaging with a complementary socket 80 formed in the head 54. As shown, the post 78 “snaps” into place within the socket 80 so that the stimulator may be used as desired. When the user wants to replace applicator 56 with another applicator, the user may press a push button 82 to “pop” the applicator 56 out of the socket. For example, a push rod 84 attached to the button 82 may contact and urge the post 78 out of the socket 80. A spring 86 may be provided to spring-operate the push button 82.

Quick-release mechanism 78 is particularly advantageous in that different applicators 56 (as described below) may be readily attached and detached from the distal portion of the head 54, as well as other dental hygiene implements, such as a toothbrush head 87 with a complementary post 78′. Accordingly, gingiva stimulator 50 may be packaged and sold as a complete dental hygiene system which may include any number of applicators 56 as well as toothbrush heads 87. Further, replacement applicators and toothbrush heads may be sold. As only the applicator or toothbrush head itself needs to be replaced with the exemplary quick-release mechanism 76, the entire head portion 54 does not need to be replaced, which is commonly required on currently available appliances. Accordingly, the cost is greatly reduced for consumers. In addition, the main body 52 and the head portion 54 may be configured as a one-piece or integral unit, which may also reduce the costs of manufacturing the stimulator of the present invention.

Another exemplary embodiment of the invention is illustrated in FIG. 8. In this embodiment, applicator 56 is integrally formed with a distal portion of the head, which is indicted by reference numeral 54′. For example, the applicator 56 and the distal portion of the head 54 may be formed in a single mold. The distal portion 54″ of the head may then be releasably attachable to a proximal portion of the head, which is indicated by reference numeral 54″, which is shown in the figure. Alternatively, the distal and proximal portions may also be integral. In this embodiment, exemplary applicator 56 and integral head 54′ may include a layer of biocompatible material 90, for example, silicone, thereby providing a desired surface for contacting tissue. In this case, the integral inner portion, indicated by reference numeral 92, may be made from a material which is more stiff (or less resilient) than the encasing layer 90.

Many alternative configurations of exemplary applicator 56 of the invention are respectively illustrated in FIGS. 9 through 17. In FIG. 9, applicator 56 has a rounded or hemispherical contact portion 100 which provides a substantially atraumatic contact surface which may be desirable in certain applications. The resilience of the material from which the main portion of applicator 56 is made and the resilience of the material from which contact portion 100 of applicator 56 is made may be different. For example, the contact portion 100 may be more resilient than the main portion of the applicator, or vice versa. The exemplary embodiment of the stimulator 50 shown in FIG. 9 may also include additional applicators and/or dental hygiene tools. For example, another applicator 102 may be disposed on the distal end of the head 54, and an interdental device 104 may be provided to clean between teeth.

As shown in FIG. 10, exemplary applicator 56 may be substantially frustum shaped. In FIG. 11, the frustum-shaped applicator 56 is modified to have a concave-shaped form. In FIG. 12, the frustum-shaped applicator 56 is mounted to the head 54 in an inverted manner. FIG. 13 illustrates a bullet-shaped applicator 56. FIG. 14 illustrates an exemplary embodiment of the stimulator 50 in which a plurality of applicators 56a and 56b are attached to the head 54. In this embodiment, applicator 56a is offset from applicator 56b by about 90 degrees, although other relationships of the multiple applicators are possible and within the scope of the invention. FIGS. 15 and 16 illustrate another exemplary embodiment of applicator 56 in which the applicator includes a textured contact surface 110. FIG. 17 illustrates yet another exemplary embodiment of the invention, in which the distal end of the head 54 includes a race 112 in which a spherical applicator 56 is rotatably received, thereby enabling the applicator to “roll” across the surface of the gums while simultaneously vibrating and, thus, stimulating blood flow.

Referencing FIG. 18, as mentioned above, exemplary applicator 56 is made from a material which is substantially firm and has a relatively low resilience. To illustrate these properties of the applicator material, if a user were to press a thumb 114 into applicator 56 under normal human strength, the applicator may deflect a distance δ. When taken into consideration with a total length L of applicator 56, deflection distance δ may range up to about 20% of length L for an applicator intended for gingival stimulation. For example, if length L is about 6 millimeters (mm), then deflection distance δ may be about 0.8 mm. Those skilled in the art will appreciate that other resiliencies of the applicator are possible depending upon the intended application. Those skilled in the art will also appreciate that there are many materials which are firm and have a low resilience, such as rubbers, plastics, silicones, and so on.

With additional reference to FIG. 1, exemplary stimulator 50 may include a speed-regulating switch 120 for used in regulating the speed, that is, the frequency, at which the head 54 vibrates. Exemplary switch 102 may adjust the vibration frequency within a predetermined range, for example, from about 400 Hz at a low end to about 520 Hz at a high end. Some users may find it more comfortable to begin massaging their gums at lower frequencies initially, while working their way up to higher frequencies as they become accustomed to the vibrating sensation of the invention.

Those skilled in the art will understand that the preceding exemplary embodiments of the present invention provide the foundation for numerous alternatives and modifications thereto. These other modifications are also within the scope of the present invention. Accordingly, the present invention is not limited to that precisely as shown and described herein.

What is claimed is:

1. A tissue stimulator for massaging gingivae, said tissue stimulator comprising:
a body including a motor;
a head attached to said body and including a distal portion and a vibrating mechanism, said vibrating mechanism in conjunction with said motor for vibrating said distal portion at a sonic frequency; and
an applicator attached to said distal portion of said head and including a contact surface, said contact surface having a surface area configured to impart to gingiva a substantial portion of the vibration of said distal portion.

2. A tissue stimulator as claimed in claim 1 wherein said surface area of said contact surface ranges from about 0.5 cm² to about 1.5 cm².

3. A tissue stimulator as claimed in claim 1 wherein said applicator is integral with said distal portion of said head.

4. A tissue stimulator as claimed in claim 1 wherein said applicator is releasably attachable to said distal portion of said head.

5. A tissue stimulator as claimed in claim 1 wherein said contact surface of said applicator is substantially planar.

6. A tissue stimulator as claimed in claim 1 wherein said contact surface of said applicator is hemispherical.

7. A tissue stimulator as claimed in claim 1 wherein said applicator is substantially cylindrical.

8. A tissue stimulator as claimed in claim 1 wherein said applicator is substantially frustum shaped.

9. A tissue stimulator as claimed in claim 1 wherein said applicator is substantially bullet shaped.

10. A tissue stimulator as claimed in claim 1 wherein said contact surface of said applicator is textured.

11. A tissue stimulator as claimed in claim 1 wherein a plurality of said applicators are attached to said distal portion of said head.

12. A tissue stimulator as claimed in claim 1 further comprising an interdental device attached to said distal portion of said head.

13. A tissue stimulator as claimed in claim 1 wherein said applicator is substantially spherical and received within a race disposed on said distal portion of said head.

14. A tissue stimulator as claimed in claim 1 wherein said application is made from resilient material.

15. A tissue stimulator as claimed in claim 1 wherein said applicator is made from biocompatible material.

16. A tissue stimulator as claimed in claim 1 wherein said contact surface has a diameter that is approximately equal to the width of a tooth.

17. A tissue stimulator for massaging gingivae, said tissue stimulator comprising:
a body including a motor and a head with a distal portion, said motor for vibrating said head at a sonic frequency; and
an applicator attached to said distal portion of said head and including a contact surface, said contact surface having a diameter that is substantially equal to a width of a tooth.

18. A tissue stimulator as claimed in claim 1 wherein said diameter of said contact surface ranges from about 0.3 cm to about 1.5 cm.

19. A method for massaging gingivae, said method comprising the steps of:
providing a tissue stimulator including:
a body including a motor and a head with a distal portion, said motor for vibrating said head at a sonic frequency; and
an applicator attached to said distal portion of said head and including a contact surface, said contact surface having a diameter that is substantially equal to a width of a tooth; and
positioning said contact surface against gingivae.

20. A method as claimed in claim 19 further comprising the step of moving said contact surface across gingivae.
